(19) United States
(12) Patent Application Publication
(10) Pub. No.: US 2009/0102081 A1
(43) Pub. Date: Apr. 23, 2009

(54) PROCESS OF USING CROSS LINKED PLASTICS AS RECOVERY MATERIAL OR MODIFIER

(76) Inventor: Heping Zhou, Guangdong (CN)

Correspondence Address: PEARNE & GORDON LLP, 1801 EAST 9TH STREET, SUITE 1200, CLEVELAND, OH, 44114-3108, US

(21) Appl. No.: 11/813,707

(22) PCT Filed: Dec. 16, 2005
(86) PCT No.: PCT/CN2005/002227

§ 371 Date: May 19, 2008

(30) Foreign Application Priority Data
Jan. 12, 2005 (CN) 200510006907.X

(51) Int. Cl. B29B 17/04

(52) U.S. Cl. 264/37.3; 264/37.1

(57) ABSTRACT

A method of reusing cross-linked plastics wastes or using cross-linked plastics wastes as modifiers is provided. Cross-linked plastic products from various sources and/or wastes thereof are crushed, smashed, and classified according to particle size. By using the wasted cross-linked plastic powder as a modifier of asphalt and resin, the modified material obtains the property of “not melted at high temperature, not brittle at low temperature”. Fine powders of various particle sizes are added into a new base material mixture in a certain proportion to replace an inorganic filler with equivalent or slightly higher volume in the formulation system, such that the performance of the product is not reduced at all, but improved.

### TECHNICAL FIELD

The present invention relates to a novel method of using cross-linked plastics and/or wastes thereof as reused materials or modifiers, mainly applicable for the processing industry of insulation layers of cross-linked wire and cable, heat-shrinkable casing, heat-shrinkable band, heat-shrinkable packaging, asphalt modification, rubber elastomer and so on, which belongs to the field of new material and new technology of environmental protection.

### Background art

In the production of cross-linked plastic products, such as insulation layers of cross-linked wire and cable, heat-shrinkable casing, heat-shrinkable band, heat-shrinkable packaging, there is a common feature that polyolefins and/or polyesters (including PE, PP, EVA, SBS, APP, PET, etc.) are used as the base material, in which a hot-melt linear polymer is converted to an unmeltable network polymer structure through a cross-linking process. During the production of the cross-linked plastics and rubber elastomer products, a large amount of wastes and defective products is unavoidably generated. As the polymer matrixes of these cross-linked wastes and defective products have been in three-dimensional network structures and lost the thermoplastic deformation capability, they cannot be melted or be completely dissolved by a solvent, and thus cannot be recycled and reused, but be disposed as waste, and specific processes for the current waste disposal include:

1. landfill treatment;

2. incineration treatment.

The two methods both have serious problems: (1) making the enterprise cost be excessively high; (2) causing wastes of a lot of resources; (3) causing bad effects on environment.

As disclosed in another patent, a method of producing hydrocarbon oil by recovering cross-linked plastics through cracking process is proposed. There are many relevant patent technologies, for example, the representative patents are listed as follows:

[CN01120570] Method and Apparatus of using Wasted Plastics and/or Heavy Oil to Produce Gasoline and Diesel Oil;

[CN01822213] Method and Apparatus of Converting Plastics Litters into Hydrocarbon Oil;

[CN99216787] Apparatus of using Wasted Plastics and/or Heavy Oil to Produce Gasoline and Diesel Oil;

[CN99107968] Method and Apparatus of using Wasted Plastics and/or Heavy Oil to Produce Gasoline and Diesel Oil;

[CN9710765 1] Method of using Wasted Plastics to Produce Petroleum Products;

[CN96116917] Method of using Wasted and Used Polyolefin Plastics to Produce Hydrocarbon Oil;

[CN94118791] Method of using Wasted Plastics to Produce Hydrocarbon Oil;

[CN93108152] Catalyst for Wasted and Used Polyolefin Plastics Degradation;

[CN93104896] Method of using Wasted Polyolefin Plastics to Produce Hydrocarbon Oil.

However, this kind of methods have significant disadvantages: if the obtained liquid gasoline and kerosene containing hydrocarbon impurities are directly used for powering vehicles, they will cause extremely high environmental cost and economic cost; if the hydrocarbon oil containing impurities is refined, the investment on the cracking and refining apparatuses is too high, which cannot be widely implemented especially in developing countries; and the cracking degree is difficult to control, the recovery is generally lower than 75% or difficult to exceed 80%, and the remaining materials cause more severe pollutions on the environment.

### CONTENTS OF THE INVENTION

The present invention is directed to a novel, low cost, high environmental protective, practicable, and reliable method of using cross-linked plastics wastes as modifiers and as reused materials, which includes the following steps.

Firstly, cross-linked plastic products in the production process or from various sources and/or the wastes thereof are classified according to the sources and then crushed; next, the crushed cross-linked plastic particles are added into a plastic pulverizer, to get a 10-380 mesh powder or a more fine powder; then, the powder is classified according to particle size through screening process and/or cyclone process and then packed.

According to the requirements for the performance of the terminal product, powders of various particle sizes are added into a new material mixture in a certain proportion and granulated according to the conventional process, so as to get reused plastic particles. The reused plastic particles are then used to produce various cross-linked or uncross-linked products according to the conventional requirements and the conventional process. As the recovered cross-linked plastic powder was added during the granulating process, in order to consider the fluidity of the melts when molding the plastics and the external appearance and inherent performance of the product, if necessary, a special polymer compatilizer is added into the mixture to replace the inorganic filler with equivalent or slightly higher volume in the formulation system, such that the performance of the product is not reduced at all, but improved.

Additionally, due to the special physical and chemical properties, the cross-linked plastics are offered with novel and extensive applications. Generally, the cross-linking degree of the cross-linked plastics is much lower than that of rubber, merely about 60%-70%, and 30-40% uncross-linked linear molecules can be melted upon being heated and thus can be extracted and dissolved by a solvent. If the cross-linked plastic powder is added into a melted asphalt (or resin) liquid, the uncross-linked linear plastic molecules will be dissolved in the asphalt liquid, such that the temperature viscosity of the asphalt is significantly improved, and the asphalt penetrates into the “space” left by the linear plastic molecules in the cross-linked plastics, such that the cross-linked plastic particles are swelled and modified. Therefore, the cross-linked plastic powder can be used as an excellent asphalt (or resin) modifier, so as to make the asphalt (or resin) “not melted at high temperature, not brittle at low temperature”. As for the modified asphalt used in roads or used in waterproofing rolling materials in building industry, the wasted cross-linked plastic powder can be reused as the modifier of asphalt or other resins, and can partially or completely replace the new plastics modifier.

Compared with the current solution of incinerating or landfilling the cross-linked plastic wastes and defective products, the present invention has the following advantages:

1. no matter in which industry the cross-linked plastic wastes and defective products is produced, they can be reused in 100%, so as to achieve the objective of “digesting in the same industry and reusing in balance without any wastes”, thus the product cost of the enterprise is significantly reduced;

2. a lot of resources are saved;

3. the environment is protected.

Compared with the pyrolysis recovery process, the present invention has the following advantages:

1. low investment, simple technology, and easy to be promoted;

2. significantly reduced reusing cost;

3. guaranteed product performance;

4. highly practical;

6. without secondary pollution on environments.

Description of Figures (no figure)

### MODE OF CARRYING OUT THE INVENTION

Specific implementations are illustrated below by two embodiments.

### Embodiment 1

### As Reused Materials

With PE and/or EVA and/or PP as raw materials, after granulation and extrusion, irradiation with cobalt-60 rays or electron accelerator, and extension, a final product of heat-shrinkable casing (band) is obtained. The wasted cross-linked plastic products generated during the above production are all collected, regardless of being tube-shaped, band-shaped or block-shaped, and then fed into to a plastics crusher to be chopped into particles; then, the crushed cross-linked plastic particles were added into a plastics pulverizer for being grinded into finer powder; after being screened through a 30-380 mesh screen, the powder was classified according to particle size through the cyclone process and then packed.

The powder of various particle sizes were added in a certain proportion into a mixture consisting of new materials, such as PE and/or EVA and/or PP, and then granulated according to the conventional process, followed by the same process required by extrusion, irradiation of cobalt-60 rays or electron accelerator, and extension, so as to produce various cross-linked or uncross-linked products. In order to considering the fluidity of the melts when molding the plastics and the external appearance and inherent performance of the product, it is suggested that the adding amount of the recovered cross-linked plastic powder in the formulation system should be maintained to be equivalent to an adding mount of the inorganic filler with equivalent or slightly higher volume, such that the stretch strength and elongation of the product is not reduced at all, but improved.

### Embodiment 2

### As Asphalt Modifier

The modified asphalt used in roads or used in waterproofing rolling materials in building industry (for example, 1 # and/or 100 # and/or 140 # asphalt) are pre-melted and added into a mixing pot with a heating mantle. The temperature was raised to and kept at 100° C.-220° C., a powder of cross-linked plastics and wastes thereof at a weight ratio of 5%-55% and other ingredients were added while stirring. Meanwhile, the prepared pipeline high-shear dispersion device is started. The temperature of the mixing pot was kept at 130° C.-200° C. for 1-8 hr, such that the linear plastic molecules in the powder of cross-linked plastics and wastes thereof were dissolved into the asphalt liquid, and thus the temperature viscosity of the asphalt was significantly improved, and the asphalt was penetrated into the “space” left by the linear plastic molecules in the cross-linked plastic powder, such that the cross-linked plastic particles was swelled and modified, which saves a large amount of novel modifiers, for example, polyolefins and/or polyesters (including PE, PP, EVA, SBS, APP). At this time, the asphalt mixture had already been made “not melted at high temperature, not brittle at low temperature”, so it can be used as an excellent base material for the modified asphalt used in roads and used in waterproofing rolling materials in building industry.

1. A novel method of using cross-linked plastics and/or wastes thereof as reused materials or modifiers, comprising reprocessing one or more of insulation layers of cross-linked wire and cable, power cable accessories, heat-shrinkable casing, heat-shrinkable band, heat-shrinkable sheet, heat-shrinkable packaging, and rubber elastomer, wherein by means of being pulverized, screened, and/or cyclone classified, the cross-linked plastics and/or wastes thereof are made into particles or powder as reused materials and/or modifiers.

2. The reused materials as claimed as claim 1, wherein the particles and/or powder material made by the cross-linked plastics and/or wastes thereof are added into a formulation system to partially or completely replace an inorganic filler and/or to be used as a body material replacing a new base material.

3. The modifier as claimed in claim 1, wherein the particles and/or powder material made by the cross-linked plastics and/or wastes thereof are added into a formulation system to modify a resin and/or asphalt to improve the performance of a main material.
